(19) United States
(12) Patent Application Publication
(10) Pub. No.: US 2016/0054560 A1
(43) Pub. Date: Feb. 25, 2016

(54) LOUPE WITH ATTACHED CAMERA

(71) Applicant: MOSHE LIOR ALKOUBY, LONDON (GB)

(72) Inventor: MOSHE LIOR ALKOUBY, LONDON (GB)

(21) Appl. No.: 14/932,263

(22) Filed: Nov. 4, 2015

Related U.S. Application Data
(63) Continuation of application No. PCT/IL2014/050760, filed on Aug. 25, 2014.
Application No. PCT/IL2014/050760 is a continuation-in-part of application No. 13/872,142, filed on Apr. 28, 2013, now Pat. No. 9,232,127.

(51) Int. Cl. G02B 25/00; H04N 5/225; G02B 27/02

(52) U.S. Cl. CPC G02B 25/007; G02B 27/027; H04N 5/2254

(57) ABSTRACT

A system and method for capturing a portion of the visual field of a loupe comprising: a loupe with at least one attached camera, a first computational device in communication with the camera, and software for operation on the first device; wherein the at least one camera captures visual data comprising a portion of the visual field of the loupe to form a capture and transmits the capture to the device for manipulation by the software.

### TECHNICAL FIELD

The present invention relates to the field of loupes. More particularly, the invention relates to a method and apparatus for capturing the visual field of a jeweler's loupe and transmitting this capture to a remote user.

### BACKGROUND ART

A loupe or a magnifying lens is a device frequently associated with jewelers, usually taking the form of a simple positive lens. In use, the magnifier is held close to the eye, while the object to be viewed is brought to the focal point of the lens. In typical use to view gems the loupe is held almost against one eye and the gem is held with tweezers and inspected through the loupe. The viewer typically inspects the surface of the gem but far more emphasis is placed on looking inside the gem for imperfections that could affect the clarity grading.

During a typical gem purchase, a buyer will inspect the gems at the seller's premises since it is very costly to ship the gems to the buyer. Further, the seller may not agree to ship the gems at all necessitating local inspection. The buyer may therefore need to send an agent to visit the seller and inspect the gems giving rise to a situation where the remote buyer does not see the gems and must rely on the inspection of the local agent. The agent may inspect hundreds or thousands of gems and the buyer might pay for the gems based on the agent's examination only to find that there are imperfections that the agent missed.

A mechanism is therefore required that allows a remote buyer to view the gems as the local agent is inspecting them. Similarly, this mechanism is also required in other fields such as the inspection and purchase of fine art or antiques.

US 20050024530 to Schuttinger teaches a magnifier for visually impaired individuals with a camera mounted on the side of the magnifier. The device of Schuttinger places the camera on the side of the magnifier and the camera does not capture the image seen through the magnifier. Further, the device does not conform to the form factor of a typical jeweler's loupe.

One existing solution requires the addition of a clip-on magnification lens to a smartphone. The clip-on lens fits over the built-in camera of the smartphone and this camera is then used to capture a magnified image or movie of the analyzed gem. The captured image is viewed locally and may be transmitted to a remote party using standard image sharing applications. This solution is not favored by industry professionals who prefer the loupe as a more natural inspection tool and find the phone unwieldy due to its relative weight and the difficulty of positioning the device over the gem to be viewed. Further the local viewer does not view the gem directly but rather sees it on the screen of the device. Finally, the standard image sharing applications do not provide any mechanism to make specific comments about the viewed object, or calculate parameters related to the object, particularly in the field of gems.

A further solution requires the local viewer to wear a head-mounted camera or camera mounted within a pair of glasses to capture the view of the gem as seen locally and then transmit this to a remote party. This approach is also not favored since the head-mounted camera does not capture the same image as seen through the loupe of the local viewer, which is held in front of the eye and not in front of the camera, and it is very difficult to line up the gem, loupe and camera to provide this view.

### SUMMARY OF THE INVENTION

The present invention overcomes the deficiencies of the background art by providing a system and method for transmitting the magnified view seen by local viewer using a handheld loupe to a remote viewer.

According to some embodiments of the present invention, the system and method provide for the addition of a camera to the loupe to capture the image seen by the local viewer as well as means for transmitting this captured image to a remote viewer. The terms local viewer and local user refer to the user that is viewing the gem or object directly and are used interchangeably herein. The term remote user or remote viewer refers to a user who is not collocated with the local user and who views a captured image or movie of the gem or object.

The term view refers to the visual field of the loupe as seen by a user looking through the lens of the loupe. The visual field may vary depending on the angle of view, the proximity to the lens and the position relative to the center of the lens.

The camera and other components described herein may be described as being attached to the loupe. The term attached may indicate that the component is integrally formed with the loupe or may indicate that it is affixed to a particular surface of the loupe.

In describing the loupe the following conventions are used herein: the proximal side is considered to be the side of the lens that is closer to the eye of the viewer. The distal side is considered to be the side closer to the object that is being viewed.

The use of the terms rays or beams herein refers to rays of light reflected off the surfaces or interior of the object being analyzed with the loupe.

According to some embodiments of the present invention, a system for capturing a portion of the visual field of a loupe comprises: a loupe with at least one attached camera; a first computational device in communication with the camera; and software for operation on the first device, wherein the at least one camera captures visual data comprising the portion of the visual field of the loupe to form a capture and transmits the capture to the device for manipulation by the software.

Preferably, the system further comprises at least a second computational device in communication with the first device, and software for operation on the at least second device, wherein the manipulation by the software on the first device comprises sharing the capture with the software on the at least second device.

Optionally, at least one camera is attached to the proximal side of the loupe. Optionally, at least one camera is attached to the distal side of the loupe.

Optionally, the system further comprises at least one beam splitter attached to the loupe for diverging the light rays representing the visual field into a plurality of divergent beam portions, wherein the at least one camera is attached to the loupe so as to capture visual data from one of the plurality of the divergent beam portions.

Optionally, at least one illumination source is attached to the loupe. Optionally, the loupe is a jewelers loupe used to view gems and the capture comprises visual data corresponding to a gem within the visual field of the loupe.

Optionally, the loupe is used for inspection of objects including works of art or valuables or is used to assess damage to an article or may be used in any situation requiring magnification. Optionally, the manipulation by the software comprises at least one of: marking points of interest on the capture, and providing means to add data about the viewed object.

Optionally, the manipulation by the software comprises at least one of: marking inclusions on the capture of the gem; determining the color of the gem; saving the capture, determining the clarity grade of the gem; determining the cut of the gem; determining the weight of the gem; determining the size of the gem; and providing means to add data about the gem.

Optionally, the capture comprises at least one of: a still image, and/or a video. Optionally, communication between the computational device and the at least one camera is based on a communication protocol selected from the group comprising: WiFi; Bluetooth; or Near field communication (NFC). Optionally, the system further comprises a button mounted on the loupe for initiating the capture.

According to some embodiments of the present invention, a method is provided for sharing visual data comprising a portion of the visual field of a loupe with a remote device for viewing on the remote device, the method comprising: providing a loupe with at least one attached camera; providing a first computational device in communication with the camera; providing a first software for operation by the first device; providing at least a second computational device in communication with the first device; providing a second software for operation by the second device; capturing the visual data by the at least one camera to form a capture; and transmitting the capture from the at least one camera to the first device for manipulation by the first software, wherein the manipulation comprises transmitting the capture to the second device for viewing on the second device using the second software.

According to some embodiments of the present invention, a system for capturing a portion of the visual field of a loupe comprises: a loupe with at least one attached camera; and a data storage device in communication with the camera, wherein the at least one camera captures visual data comprising the portion of the visual field of the loupe to form a capture and stores the capture in the data storage device.

Optionally, the data storage device further comprises a memory card slot and a memory card inserted into the slot. Optionally, the data storage device further comprises a data connection port connected to a computing device.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computational device”, a “computing device”, a “computer”, or “device” on a “computer network” or simply “network”, it should be noted that optionally any device featuring a data processor and the ability to execute one or more instructions may be described as a computer or computing device, including but not limited to any type of personal computer (PC), a server, a cellular telephone, an IP telephone, a smartphone, a tablet, a PDA (personal digital assistant), or a pager. Any two or more of such devices in communication with each other may optionally comprise a “network”.

### BRIEF DESCRIPTION OF DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified pictorial illustration of light rays passing through a prior art magnifying lens such as that found in a loupe;

FIG. 2 is a simplified pictorial illustration of light rays passing through a loupe according to some embodiments of the present invention;

FIG. 3 is a simplified pictorial side view illustration of a loupe with an attached camera according to some embodiments of the present invention;

FIG. 4 is a simplified pictorial top perspective illustration of a loupe with an attached camera according to some embodiments of the present invention;

FIG. 5 is a simplified pictorial perspective view of the loupe with an attached camera partially folded into an associated handle according to some embodiments of the present invention;

FIGS. 6A, 6B, and 6C are simplified pictorial top and bottom view illustrations of a loupe according to some embodiments of the present invention;

FIG. 7 is a simplified pictorial cross sectional illustration of a loupe with a camera and beam splitter according to some embodiments of the present invention;

FIG. 8A is a simplified pictorial top view illustration of a loupe with a camera positioned to view a gem according to some embodiments of the present invention;

FIG. 8B is an exemplary view of the screen of an application for capturing an image transmitted by the loupe with a camera according to some embodiments of the present invention.

It should be understood that the drawings are not necessarily drawn to scale.

### DESCRIPTION OF THE PREFERRED EMBODIMENTS

The present invention is of a system and method for transmitting the magnified view seen by local viewer using a handheld loupe to a remote viewer. To capture the view seen by the local user, the loupe is equipped with a camera preferably mounted on, or proximal to, the standard loupe lens. The loupe preferably includes means for transmitting the image captured by the camera to a nearby computing device such as a smartphone or laptop computer. These computing devices in turn preferably transmit the images to a remote viewer so that this viewer can essentially see what the local user sees.

The loupe is preferably equipped with a button or other means allowing the local user to initiate image capture. The user may also optionally capture video and the term captured view or capture as used herein may refer to either image or video. The captured view is optionally stored locally on the loop and can then be copied from the loupe.

Optionally the camera is mounted on the proximal side of the loupe lens closer to the user such that the camera captures the view seen through the lens. Optionally the camera is mounted on the distal side closer to the object to be viewed where the camera includes optics that allow approximation of the view on proximal side of the loupe lens. Optionally, the loupe includes a beam splitter or similar optical component so that the camera and viewer are presented with identical views. Optionally, the loupe includes more than one camera to capture different views of the viewed object. Optionally the loupe is equipped with means for illumination on the distal side to illuminate the viewed object.

Preferably, the capture is transferred to a computing device wirelessly. Optionally the capture is transferred manually using some form of portable media that is inserted or otherwise attached to the loupe. Optionally a cable may be used to connect the loop with a computing device to allow transfer of the captures from the loop to the computing device.

Preferably, the computing device is running dedicated software herein referred to as an application or app. The app preferably includes capabilities such as; establishing a wireless connection to the loupe, receiving and displaying captures transmitted by the loupe, annotating captures, storing captures, and sharing captures. Preferably the remote user uses the same app running on a computing device to view the shared captures.

Optionally the captures are shared using non-dedicated software running on the computing device. Non-limiting examples of non-dedicated software include email or other messaging applications or services such as instant messaging.

In an exemplary and non-limiting usage scenario a user would activate the app on a smartphone and initiate a wireless connection to the loupe. The user would then initiate a connection to a remote user who is also running the app on a smartphone. The user then holds the gem or object to be analyzed in one hand and holds the loupe in the other hand and positions the loupe close to the eye. The object may also, for example, be of dimensions, or of value such that it is not possible to hold the object. Thus the loupe may for example be used to inspect works of art, or damage to an article or any other type of viewing requiring magnification.

The gem or object is then held at the focal length of the loupe, or the loupe and viewer move to a focal length opposite the object, and the gem or object is examined. When the user sees a point of interest the capture is initiated. This capture is transmitted to the app on the local smartphone and transferred to the app on the smartphone of the remote user where the capture of the view seen by the local user is displayed on the screen of the device.

Optionally the various embodiments and subembodiments of the below figures may also optionally be combined. Some non-limiting examples of such combinations are provided below, but these are only examples and any other combination may also be considered to fall within the scope of the present invention.

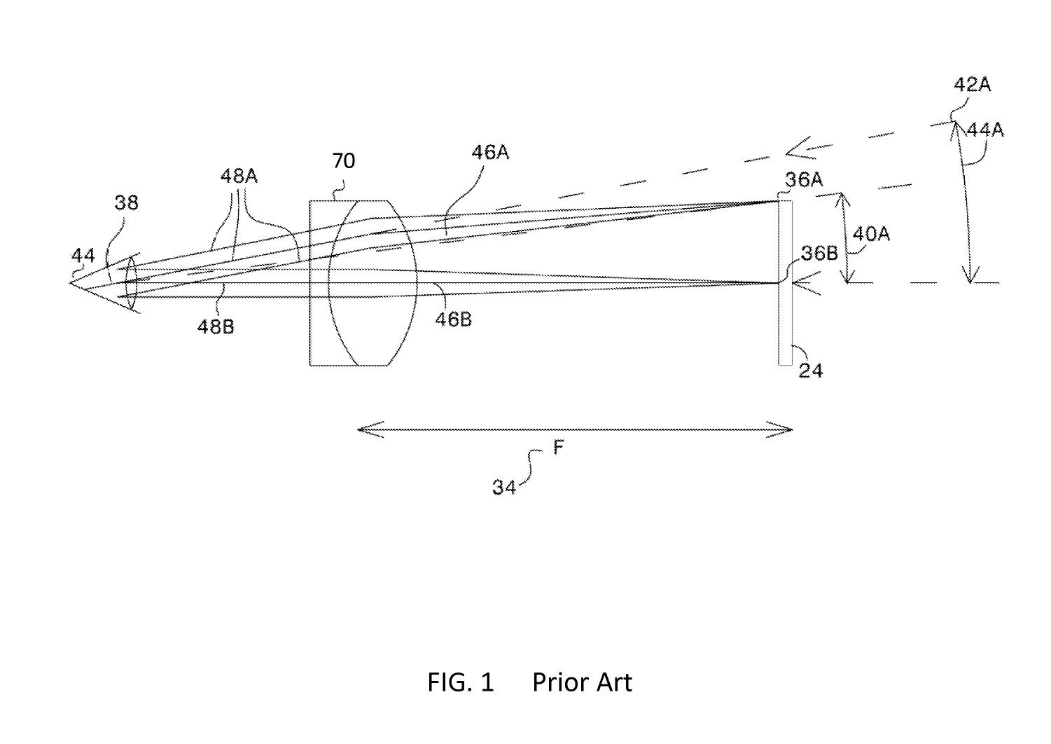

Reference is now made to FIG. 1 which is a simplified pictorial illustration of light rays passing through a prior art magnifying lens such as that found in a loupe. A prior art lens 70 is a convex lens. The typical distance of the viewed object 24 from lens 70 is the focal length 34 of lens 70. Thus, lens 70 directs all the rays 46A emanating from point 36A of object 24 to be parallel one to the other, being rays 48A; and lens 70 directs all the rays 46B emanating from point 36B of object 24 to be parallel one to the other, being rays 48B.

Parallel rays 48A and 48B emanating towards eye 38 provide relaxed focusing of the eye to the retina 44. Thus, eye 38 imagines that rays 46A emanating from point 36A coming from an angle 40A, emanate from an infinite object 42A having an angle 44A.

The term “infinity rays” refers herein to parallel rays 48A and 48B, since they resemble rays emanating from a very distant object. Thus, the magnification that lens 70 provides is angle 44A divided by angle 40A.

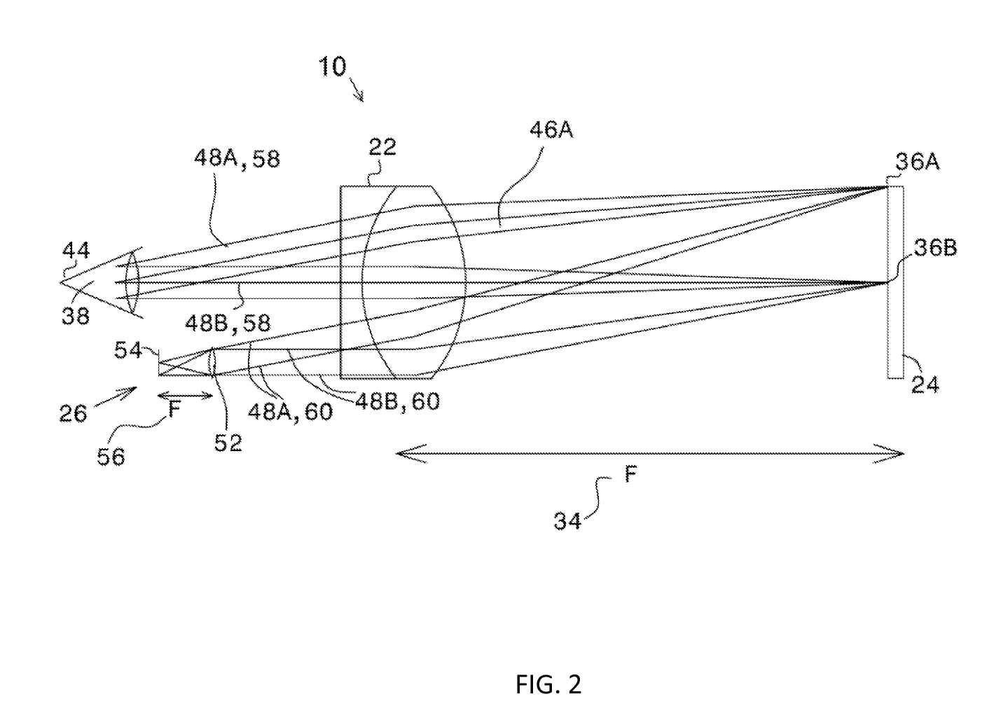

Reference is now made to FIG. 2 which is a simplified pictorial illustration of light rays passing through a loupe according to some embodiments of the present invention. Loupe 10 includes a camera 26, and lens 22. Camera 26 may be an infinity-focus camera or may be an auto-focus camera including the mechanisms necessary to allow it to focus on the object examined through the loupe. In FIG. 2 lens 22 directs parallel rays 48A and 48B to the eye 38 and also to camera 26. A first portion 58 of infinite rays 48A and 48B emanate towards eye 38, and a second portion 60 of infinite rays 48A and 48B emanate towards camera 26.

As shown in FIG. 2 camera 26 includes a lens 52 disposed at a fixed distance from the image sensor thereof 54, the distance being the focal length 56 of lens 52. Camera 26 is preferably positioned on the proximal side of lens 22 and near the edge of lens 22 so that camera 26 does not obstruct the view of eye 38. Preferably, camera 26 must be designed and positioned such that the view seen by camera 26 and the resultant capture is as close as possible to the view of eye 38 through the center of lens 22.

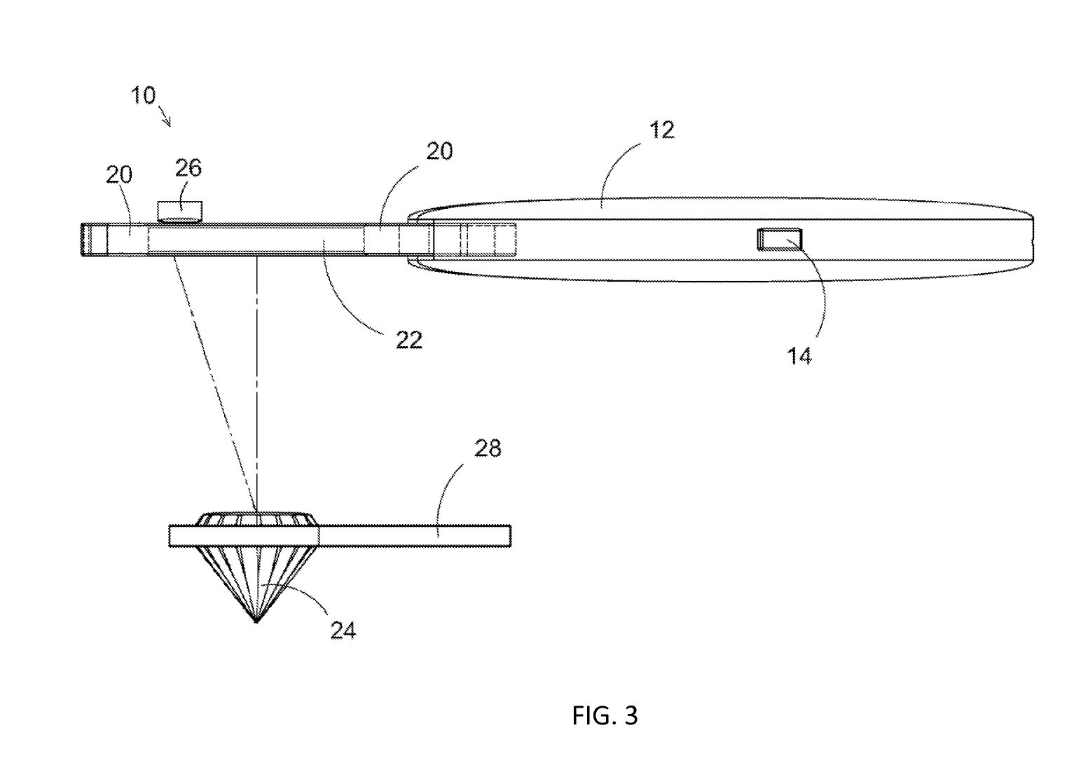

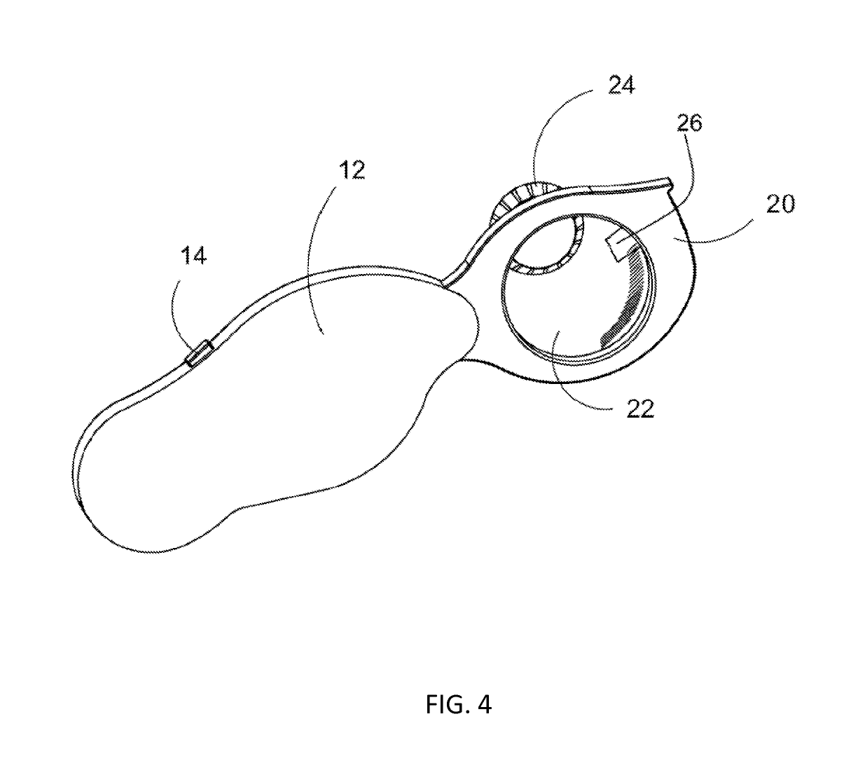

Reference is now made to FIG. 3 which is a simplified pictorial side view illustration and FIG. 4 which is a simplified pictorial top perspective illustration of a loupe with an attached camera according to some embodiments of the present invention. As shown, a gem 24 held by tweezers 28 is visible through lens 22, directly by the viewer and also by camera 26 which is mounted on the edge of the proximal side of lens 22. Lens 22 preferably provides 10× magnification. Optionally lens 22 provides magnification between 2× and 10×. Optionally lens 22 provides magnification between 10× and 30×. Optionally lens 22 comprises more than one lens. Lens 22 preferably has a diameter between 12 and 22 mm. Lens 22 preferably has a focal range between ⅛ of an inch to about 1¼ of an inch.

Optionally camera 26 may be fixed at an angle where it is tilted to better face the object that is being examined. Camera 26 is positioned on the edge of lens 22 so as to capture the view through lens 22 without disrupting the view of the user through lens 22.

Lens 22 is surrounded by a frame 20, pivotally connected to a handle 12. Optionally, handle 12 includes a button 14 for activating the capture. Optionally, a short press on button 14 captures a still image, and a long press on button 14 captures a video. Optionally, a further press on button 14 stops video capture.

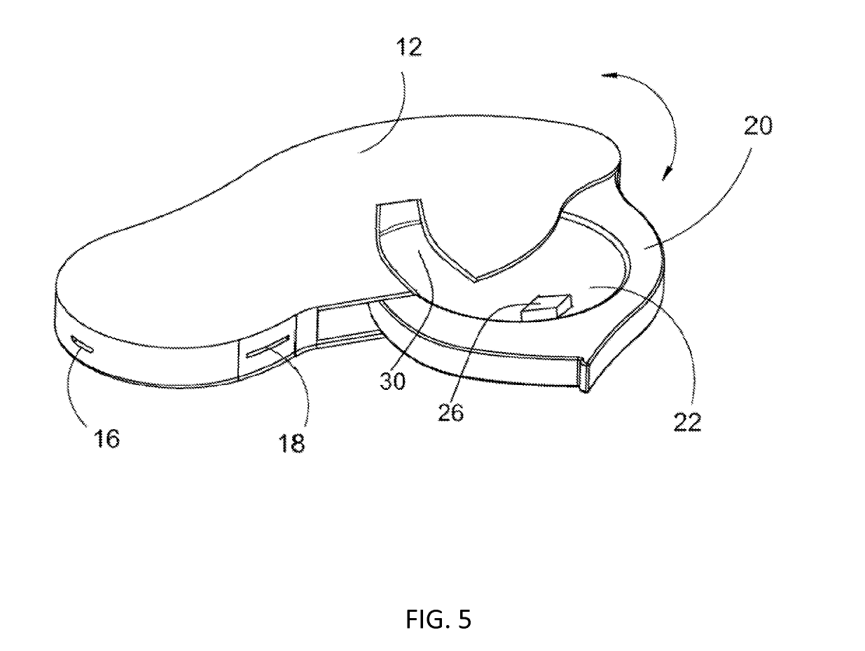

Reference is now made to FIG. 5 which is a simplified pictorial perspective view of the loupe with an attached camera partially folded into an associated handle according to some embodiments of the present invention. In the depicted embodiment a data connection port 16 and memory card slot 18 are provided. Captures from camera 26 are optionally stored on internal camera memory (not shown) or optionally on a memory card (not shown) inserted into slot 18. Non-limiting examples of memory cards that may inserted into slot 18 and used to store captures include secure digital (SD), MiniSD, MicroSD, Memory Stick DUO, Memory Stick PRO-HG Duo, Memory Stick Micro M2, and others. Data connection port 16 allows the connection of a data cable for transfer of captures to a computing device (not shown) from the memory (not shown) of camera 26 or from the memory card (not shown) inserted into slot 18. Non-limiting examples of data ports include Universal Serial Bus (USB), IEEE 1394 (FireWire), Thunderbolt, or others.

Loupe 10 is shaped like a prior art loupe and may be folded similarly. For example, a depression 30 within handle 12 encasing lens 22, may allow sliding camera 26 therewithin, for folding lens 22 within handle 12.

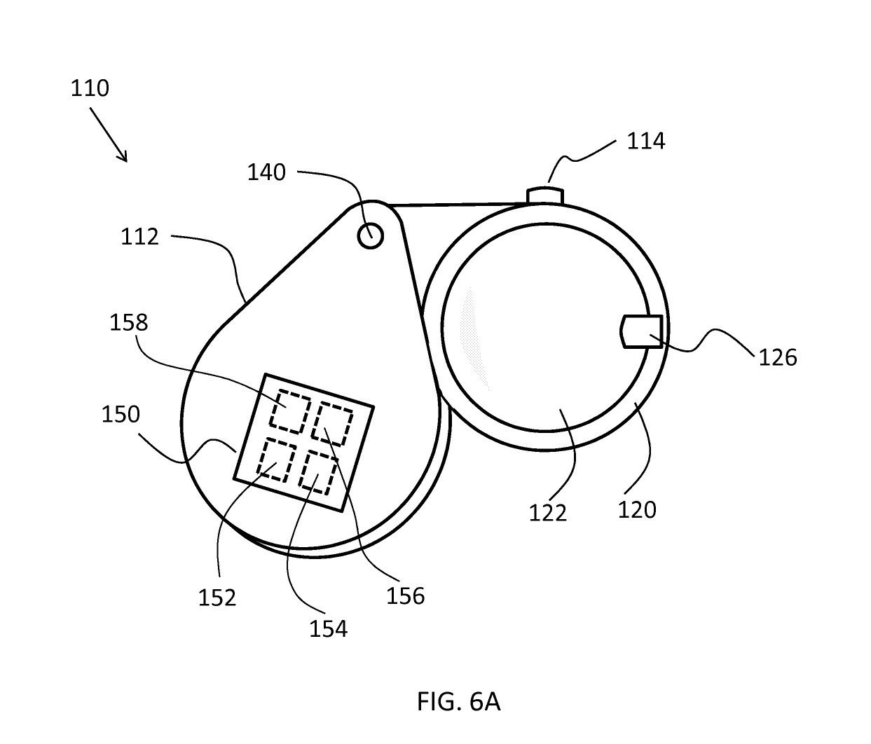

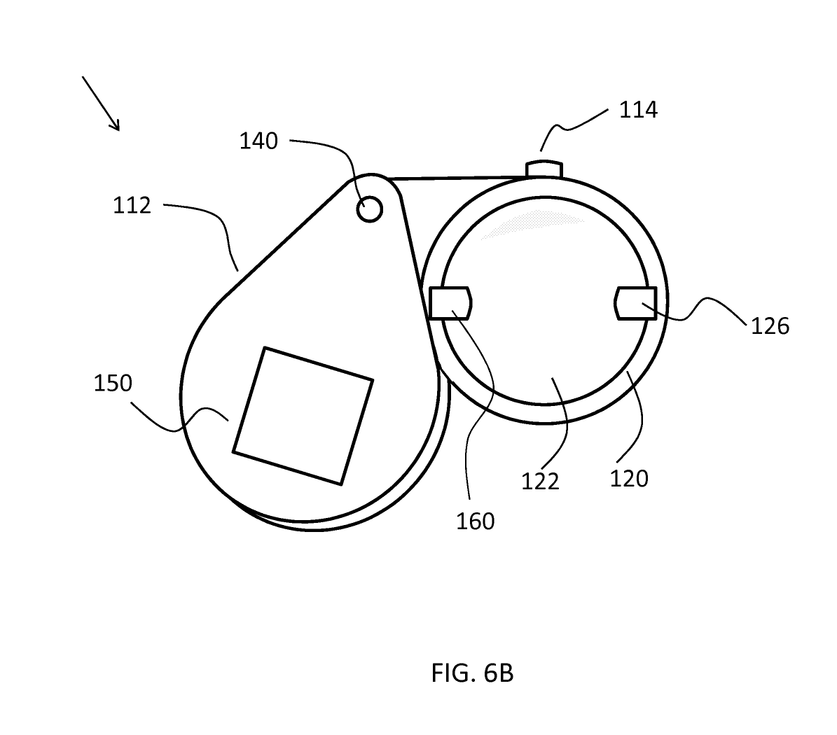

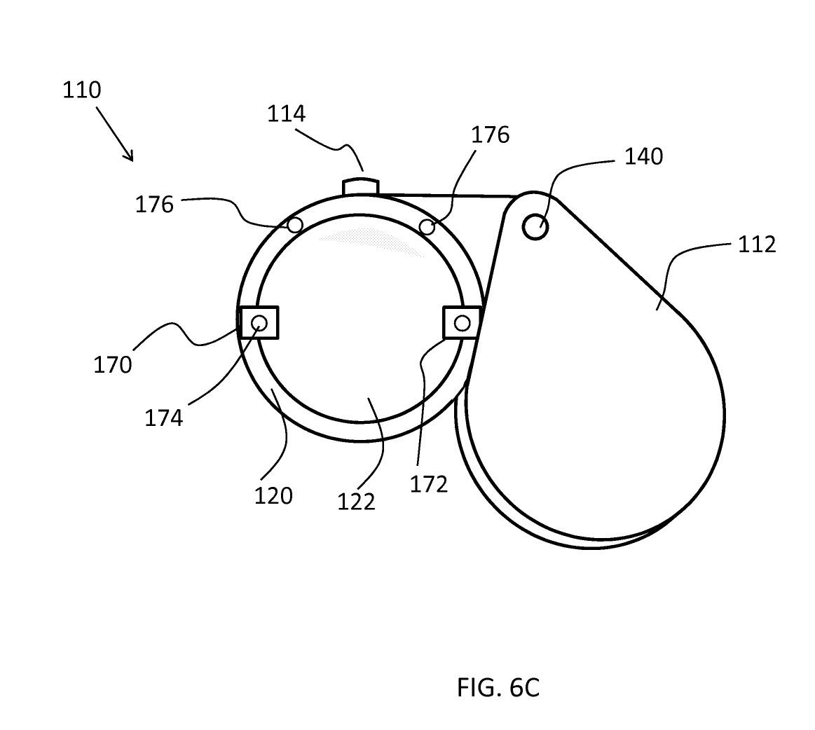

Reference is now made to FIGS. 6A, 6B, and 6C which are simplified pictorial top and bottom view illustrations of a loupe according to some embodiments of the present invention. As shown in FIG. 6A, a loupe 110 comprises a lens 122 surrounded by a frame 120 is connected to a handle 112 via pivot 140. Lens 122 may be folded into handle 112 when not in use.

Lens 122 preferably provides 10× magnification. Optionally lens 122 provides magnification between 2× and 10×. Optionally lens 122 provides magnification between 10× and 30×. Optionally lens 122 comprises more than one lens. Lens 122 preferably has a diameter between 12 and 22 mm. Lens 122 preferably has a focal range between ⅛ of an inch to about 1¼ of an inch.

Camera 126 is mounted on the edge of the proximal side of lens 122 so as not to disrupt the view of the user through lens 122 while being positioned to capture the view that is almost the same as that seen by the loupe user. Optionally camera 126 may be positioned at a fixed angle to better face the object that is being examined.

Button 114 is preferably mounted on frame 120. Button 114 is pressed by the user of the loupe to activate the capture. Optionally, a short press on button 114 captures a still picture, and a long press on button 114 captures a video. Optionally, a further press on button 114 stops video capture.

Raised enclosure 150 preferably houses data storage 152, wireless communication interface 154, controller 156, and battery 158. Data storage 152 stores captures from camera 126.

Wireless interface 154 preferably enables communication between loupe 110 and a nearby computing device that is within 10 meters of loupe 110. Any type of short range wireless interface may be used. Non-limiting examples of interfaces include WiFi, Bluetooth, or Near field communication (NFC). Optionally, a wired interface port (not shown) is provided for connecting to the nearby computing device with a suitable data cable.

Controller 156 manages the storage of captures and the transfer of these via wireless communication interface to an external computing device. Controller 156 also manages establishment of communications with an external computing device via interface 154. Controller 156 is connected to button 114 and camera 126 so as to manage their functioning.

Battery 158 provides power to storage 152, interface 154, and controller 156. Battery 158 is preferably rechargeable and loupe 110 is provided with connection means (not shown) to recharge battery 158. Alternatively battery 158 is not rechargeable and raised enclosure 150 may be opened to allow replacement of battery 158.

Optionally storage 152, communication interface 154, controller 156 and battery 158 may be enclosed or housed in any part of loupe 110 such that raised enclosure 150 is not needed.

FIG. 6B depicts the loupe described with reference to FIG. 6A with the addition of a second camera 160. Second camera 160 may be positioned to capture an alternate view to that captured by camera 126. Additional cameras (not shown) may similarly be added to loupe 110.

FIG. 6C depicts the loupe described with reference to FIG. 6A shown from the distal side. In this embodiment camera 170 and second camera 172 are mounted on the distal side of lens 122. Cameras 170 and 172 preferably combine optical components, such as camera lens 174, and digital zoom to provide a capture that approximates the view seen by the user on the proximal side of lens 122. Optionally, only one camera may be provided. Optionally, more than 2 cameras may be provided.

Optionally, illumination source 176 is mounted on frame 120 to illuminate the object being examined through the loupe. Preferably illumination source 176 is a light emitting diode (LED). Optionally, multiple illumination sources may be provided. Optionally, illumination source 176 may emit ultraviolet light to aid in the detection of clarity enhanced gems.

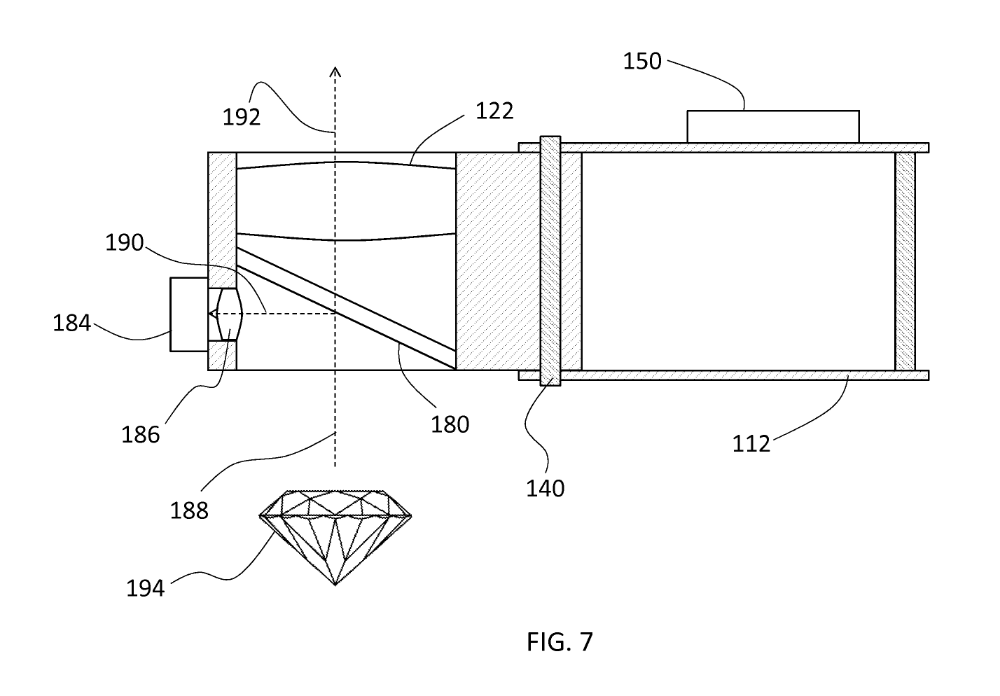

Reference is now made to FIG. 7 which is a simplified pictorial cross sectional illustration of a loupe with a camera and beam splitter according to some embodiments of the present invention. The beam splitter 180 splits the rays from the viewed object 194 so that an incident ray 188 striking the splitter 180 both passes through the splitter 180 and is reflected off the splitter 180. As shown, camera 184 is positioned to capture the reflected rays 190 while the rays that pass through 192 are magnified by lens 122 before being viewed by the user.

This arrangement allows camera 184 to capture the identical view seen by the user. Optionally camera 184 is provided with optical components such as lens 186 and digital zoom to mimic the magnification provided by lens 122.

Beam splitter 180 may be based on any beam splitter type known in the art including but not limited to a cube formed from 2 prisms, a half-silvered mirror or similar flat surface, or a dichroic prism.

The introduction of a beam splitter may reduce the light intensity from the viewed object and it may therefore be necessary to include an illumination source, such as illumination source 176 depicted in FIG. 6C, to compensate for this reduction.

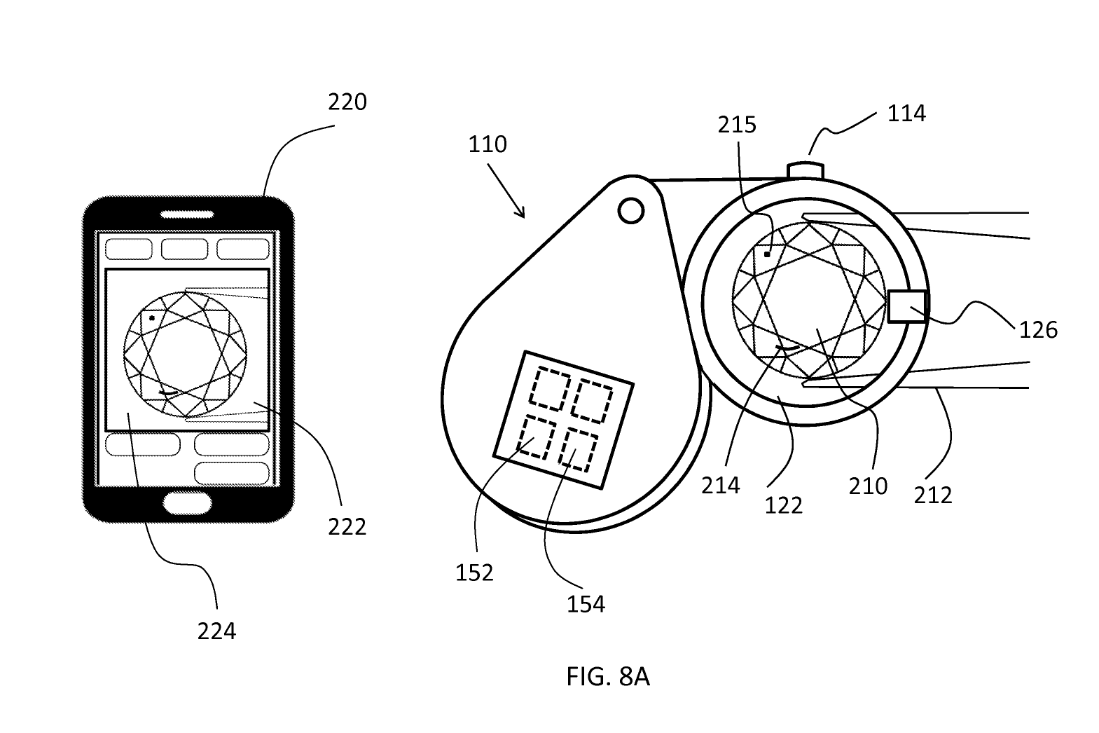

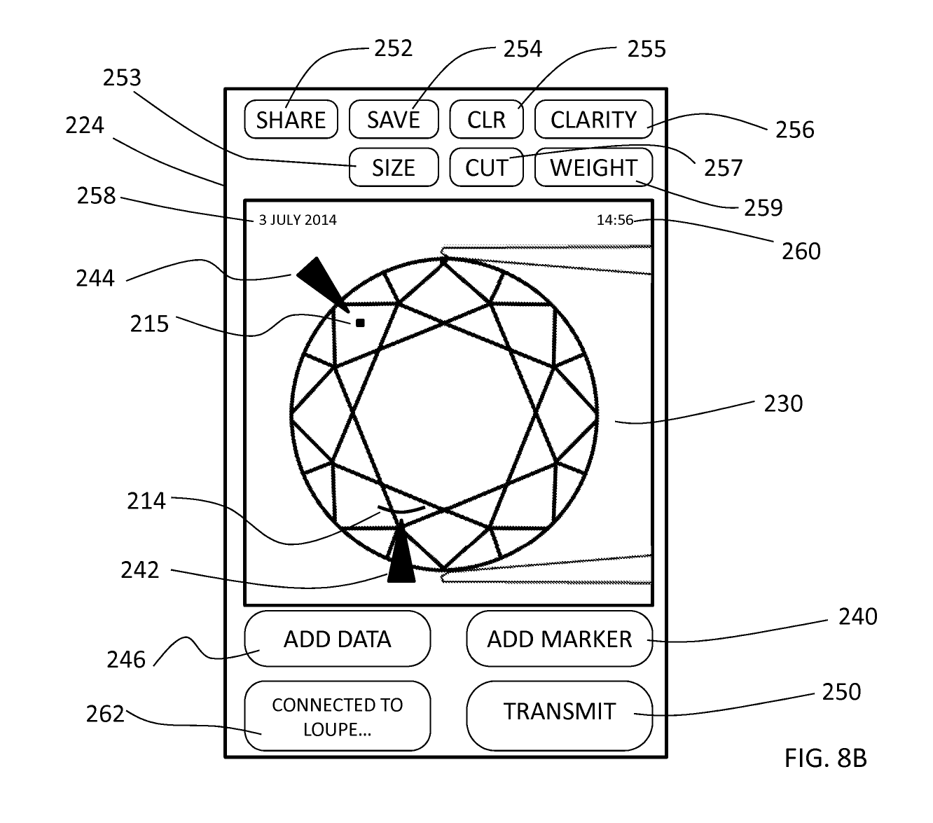

Reference is one made to FIG. 8A which is a simplified pictorial top view illustration of a loupe with a camera positioned to view a gem and FIG. 8B which is an exemplary view of the screen of an application for capturing an image transmitted by the loupe with a camera according to some embodiments of the present invention.

As shown in FIG. 8A, gem 210 is examined using loupe 110. Gem 210 is held by tweezers 212. The purpose of examination is to determine to what extent the gem is flawed. Typically, the viewer looks for surface blemishes including but not limited to polish lines, grain boundaries, naturals, scratches, nicks, pits, chips, and breaks as well as internal inclusions including but not limited to clouds, feathers, included crystals or minerals, knots, cavities, cleavage, bearding, internal graining, pinpoint, and laser lines.

Gem 210 is shown as including inclusions 214 and 215 which are visible after being magnified by lens 122. Loupe 110 is in wireless communication with nearby mobile computing device 220 via communication interface 154. When the loupe user presses button 114, the view of the gem through lens 122 is captured by camera 126. The captured image is optionally stored in storage 152 and then transmitted via communication interface 154 to mobile device 220.

Mobile device 220 is preferably running a dedicated app for receiving, editing and transmitting of the capture from loupe 110. The screen 222 of device 220 is used to display the user interface 224 of the app. User interaction with the app is via the interface mechanism which depends on the interface capabilities of the device. Non-limiting examples of interface mechanisms include a touch screen, keyboard, pointing device or others.

The exemplary app user interface 224 displays the capture 230 received from loupe 110. The capture shows the gem 210 and its inclusions 214 and 215 which were seen directly through loupe 110. The app preferably provides the following functionality based on virtual buttons presented in app interface 224:

Add marker button 240 preferably allows the user to annotate the capture with indicators such as indicator 242 and indicator 244 that are positioned to point out inclusions 214 and 215 respectively. Optionally the user may add text annotations to the capture (not shown);

Add data button 246 preferably allows the addition of standard gem data such as the color, cut or weight, which is then combined with the capture—optionally by addition of fields to the EXIF headers of the capture;

Transmit button 250 preferably allows the local user to establish a connection with a remote user who is also running dedicated app on a computing device. The connection is established over a network using any network technology including but not limited to a local area network, a wide area network, the Internet, a wireless data network including: a cellular network, a WiMAX network, an EV-DO network, an RTT network, a Flash-OFDM network, an iBurst network, an HSPA network, an EDGE network, a GPRS network, a GPS satellite network, a Wi-Fi network, a UTMS network, an LTE network, and/or any combination of the aforesaid networks, which may optionally be private or public networks.

Once a transmit session has been initiated with a remote user, all captures will automatically be sent to the remote user for display on the remote device. Optionally, the session includes two-way audio transmission allowing the local and remote users to discuss the captures;

Share button 252 preferably allows the user to share the capture with a third party. The sharing may optionally be to a user who is running the dedicated app on a different device. Alternatively the sharing may make use of messaging applications known in the art. Use of the dedicated app provides additional functionality over known sharing applications such as ability to easily view the added data that was provided using the add data button 246 as described above.

Save button 254 preferably allows a user to save a copy of the capture on the local device 220. Markers, such as markers 242 and 244 are also saved along with any data added using the add data button 246.

CLR or color button 255 provides an automatically assessed measure of the gem color. The color is assessed by comparing the color in the capture to a local or remote database of gem colors. The user can optionally override the suggested color and choose a different color.

Clarity button 256 provides an automatically assessed measure of the gem clarity. In the case of a diamond the clarity grades include: Flawless (FL), Internally Flawless (IF), Very, Very Slightly Included (VVS1 and VVS2), Very Slightly Included (VS1 and VS2), Slightly Included (SI1 and SI2), and Included (I1, I2, and I3). Similarly, clarity grades for other types of gems cold be automatically assessed.

Based on the inclusions pointed out by the user using markers, such as markers 242 and 244, and based on size data provided using the add data button 246, the app preferably suggests a clarity grade. The user can optionally override the suggested grade and choose a different grade. Optionally app scans capture 230 for inclusions and suggests a clarity grade without the need for the user to mark the inclusions.

Optionally, app determines the size of the gem following selection of size button 253 based on markers on the tweezers 212 or based on a calibration determined by the size of lens 122 or based on distance of the gem from the lens 122 measured by the camera or based on a combination of these. Optionally, the cut and/or the weight are provided using the add data button 246. Optionally, the cut is determined automatically by comparing the capture to a local or remote database of cuts after selecting cut button 257. Optionally, the weight in carats is calculated based on the size and cut after selecting weight button 259. Optionally, the assessment of clarity, color, cut, weight and size are all performed automatically based on the capture without the need for user input.

In addition the app provides other indicators and data including:

The date 258 and time 260 of the local viewer which are optionally displayed on the capture and which may be stored with the capture to validate the capture date and time;

Loupe connection indicator 262 provides confirmation that loupe 110 is wirelessly connected to mobile device 220. If loupe 110 is not connected then the user will optionally be guided through the process of connection.

While the invention has been described with respect to a limited number of embodiments, it will be appreciated that many variations, modifications and other applications of the invention may be made

What is claimed is:

1. A system for capturing a portion of the visual field of a loupe comprising:
i) a loupe with at least one attached camera;
ii) a first computational device in communication with said camera; and
iii) software for operation on said first device;
wherein said at least one camera captures visual data comprising said portion of said visual field of said loupe to form a capture and transmits said capture to said device for manipulation by said software.

2. The system of claim 1 further comprising:
i) at least a second computational device in communication with said first device; and
ii) software for operation on said at least second device;
wherein said manipulation by said software on said first device comprises sharing said capture with said software on said at least second device.

3. The system of claim 1 wherein said at least one camera is attached to at least one of the proximal side of said loupe or to the distal side of said loupe.

4. The system of claim 1 further comprising:
i) at least one beam splitter attached to said loupe for diverging the light rays representing said visual field into a plurality of divergent beam portions;
wherein said at least one camera is attached to said loupe so as to capture visual data from one of said plurality of said divergent beam portions.

5. The system of claim 1 further comprising at least one illumination source attached to said loupe.

6. The system of claim 1 wherein said loupe is a jewelers loupe used to view gems and said capture comprises visual data corresponding to a gem within the visual field of said loupe.

7. The system of claim 6 wherein said manipulation by said software comprises at least one of:
i) marking inclusions on said capture of said gem;
ii) determining the color of said gem;
iii) saving said capture,
iv) determining the clarity grade of said gem;
v) determining the cut of said gem;
vi) determining the weight of said gem;
vii) determining the size of said gem; or
viii) providing means to add data about said gem.

8. The system of claim 1 wherein said capture comprises at least one of:
i) a still image; and/or
ii) a video.

9. The system of claim 1 further comprising a button mounted on said loupe for initiating said capture.

10. A method for sharing visual data comprising a portion of the visual field of a loupe with a remote device for viewing on said remote device, the method comprising:
i) providing a loupe with at least one attached camera;
ii) providing a first computational device in communication with said camera;
iii) providing a first software for operation by said first device;
iv) providing at least a second computational device in communication with said first device;
v) providing a second software for operation by said second device;
vi) capturing said visual data by said at least one camera to form a capture; and
vii) transmitting said capture from said at least one camera to said first device for manipulation by said first software,
wherein said manipulation comprises transmitting said capture to said second device for viewing on said second device using said second software.

11. The method of claim 10 wherein said at least one camera is attached to at least one of the proximal side of said loupe or the distal side of said loupe.

12. The method of claim 10 wherein said loupe further comprises:
i) at least one beam splitter attached to said loupe for diverging the light rays representing said visual field into a plurality of divergent beam portions;
wherein said at least one camera is attached to said loupe so as to capture visual data from one of said plurality of said divergent beam portions.

13. The method of claim 10 wherein said loupe further comprises at least one illumination source attached to said loupe.

14. The method of claim 10 wherein said loupe is a jewelers loupe used to view gems and said capture comprises visual data corresponding to a gem within the visual field of said loupe.

15. The method of claim 14 wherein said manipulation by said first software comprises at least one of:
i) marking inclusions on said capture of said gem;
ii) determining the color of said gem;
iii) saving said capture,
iv) determining the clarity grade of said gem;
v) determining the cut of said gem;
vi) determining the weight of said gem;
vii) determining the size of said gem; or
viii) providing means to add data about said gem.

16. The method of claim 10 wherein said loupe further comprises a button mounted on said loupe for initiating said capture.

17. A system for capturing a portion of the visual field of a loupe comprising:
i) a loupe with at least one attached camera; and
ii) a data storage device in communication with said camera;
wherein said at least one camera captures visual data comprising said portion of said visual field of said loupe to form a capture and stores said capture in said data storage device, wherein said loupe is a jewelers loupe used to view gems and said capture comprises visual data corresponding to a gem within the visual field of said loupe.

18. The system of claim 17 wherein said at least one camera is attached to at least one of the proximal side of said loupe or to the distal side of said loupe.

19. The system of claim 17 further comprising:
i) at least one beam splitter attached to said loupe for diverging the light rays representing said visual field into a plurality of divergent beam portions;
wherein said at least one camera is attached to said loupe so as to capture visual data from one of said plurality of said divergent beam portions.

20. The system of claim 17 further comprising at least one illumination source attached to said loupe.
